(19) United States
(12) Patent Application Publication
(10) Pub. No.: US 2009/0009284 A1
(43) Pub. Date: Jan. 8, 2009

(54) Biometric information sharing system, biometric information presentation apparatus, and biometric information presentation method

(75) Inventor: Yoichiro Sako, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/215,599

(22) Filed: Jun. 26, 2008

(30) Foreign Application Priority Data
Jul. 2, 2007 (JP) JP2007-174311

(51) Int. Cl. G06F 7/04

(52) U.S. Cl. 340/5.82

(57) ABSTRACT

A biometric information sharing system, includes a biometric information detection and transmission apparatus, and a biometric information presentation apparatus. The biometric information detection and transmission apparatus includes a detection unit for detecting biometric information of a subject, and a transmission unit for transmitting the biometric information detected by the detection unit. The biometric information presentation apparatus includes a communication unit for performing information communications, an actuation unit for presenting the biometric information in a predetermined mode, and a control unit for causing the communication unit to receive the biometric information and controlling the actuation unit in response to the biometric information received by the communication unit.

### CROSS REFERENCES TO RELATED APPLICATIONS

The present invention contains subject matter related to Japanese Patent Application JP 2007-174311 filed in the Japanese Patent Office on Jul. 2, 2007, the entire contents of which are incorporated herein by reference.

### BACKGROUND OF THE INVENTION

1. Field of the Invention

The present invention relates to a biometric information sharing system, a biometric information presentation apparatus, and a biometric information presentation method and, in particular, to a technique for sharing biometric information of other persons.

2. Description of the Related Art

Japanese Unexamined Patent Application Publication No. 2006-126891 discloses a technique relating to a network transmission of biometric information. Apparatuses for displaying a variety of biometric information are disclosed in Japanese Unexamined Patent Application Publications Nos. 2006-34803, 2006-87829, 2003-79591 and 2004-194996.

### SUMMARY OF THE INVENTION

None of the systems proposed allows biometric information of another person to be viewed or felt.

If biometric information of an acquaintance or a well-known person is physically felt, a new type of pleasure is expected. It is thus desirable to provide a system and an apparatus for sharing easily biometric information.

In accordance with one embodiment of the present invention, a biometric information sharing system includes a biometric information detection and transmission apparatus, and a biometric information presentation apparatus. The biometric information detection and transmission apparatus includes a detection unit for detecting biometric information of a subject, and a transmission unit for transmitting the biometric information detected by the detection unit. The biometric information presentation apparatus includes a communication unit for performing information communications, an actuation unit for presenting the biometric information in a predetermined mode, and a control unit for causing the communication unit to receive the biometric information and controlling the actuation unit in response to the biometric information received by the communication unit.

The biometric information sharing system may further includes a server including storage unit storing the biometric information. The transmission unit in the biometric information detection and transmission apparatus uploads the biometric information to the server. The server stores on the storage unit thereof the uploaded biometric information. The communication unit in the biometric information presentation apparatus receives the biometric information downloaded from the storage unit in the server.

The biometric information contains at least one piece of information selected from the group consisting of pulse, heart rate, an electrocardiogram signal, electromyogram, respiration (respiratory rate, respiratory depth, respiratory amount), perspiration, galvanic skin response (GSR), blood pressure, blood oxygen saturation (SpO₂), skin surface temperature, electroencephalogram (alpha (α) wave, beta (β) wave, theta (θ) wave and delta (δ) wave), a blood flow change (such as a change in cerebral blood flow or peripheral blood flow detected by near-infrared spectroscopy), body temperature, body motion (yawing), head motion (swing), center of gravity, rhythm of walking and running, and the state of the eyes (papillary state, movement of eyes, and nictitation).

The server may store on the storage unit thereof the uploaded biometric information with identification information of the subject associated therewith.

The communication unit in the biometric information presentation apparatus downloads part of the biometric information selected from the biometric information, stored on the storage unit in the server, in accordance with the identification information.

In accordance with one embodiment of the present invention, a biometric information presentation apparatus includes a communication unit for performing information communications, an actuation unit for presenting biometric information in a predetermined mode, and a control unit for causing the communication unit to receive the biometric information and controlling the actuation unit in response to the biometric information received by the communication unit.

The control unit may cause the communication unit to download part of biometric information selected from the biometric information stored on an external server. The server may store the biometric information with identification information of a subject associated therewith, and the control unit may select part of the biometric information to be received, from the biometric information stored on the server, in accordance with the identification information.

The actuation unit may include a vibrator, and the control unit may generate a drive control signal in response to the biometric information received by the communication unit and control the vibrator to vibrate in response to the drive control signal.

The actuation unit may include a shape changer, and the control unit may generate a drive control signal in response to the biometric information received by the communication unit and control the shape changer to change a shape thereof in response to the drive control signal.

The actuation unit may include a pressure applier, and the control unit may generate a drive control signal in response to the biometric information received by the communication unit and control the pressure applier to apply pressure in response to the drive control signal.

The actuation unit may include a temperature changer, and the control unit may generate a drive control signal in response to the biometric information received by the communication unit and control the temperature changer to change a temperature thereof in response to the drive control signal.

The actuation unit may include a moisture changer, and the control unit may generate a drive control signal in response to the biometric information received by the communication unit and control the moisture changer to change a moisture state thereof in response to the drive control signal.

The actuation unit may include an image display, and the control unit may generate an image signal in response to the biometric information received by the communication unit and control the image display to display an image in response to the image signal.

The actuation unit may include an audio output unit, and the control unit may generate an audio signal in response to the biometric information received by the communication unit and control the audio output unit to output an audio in response to the audio signal.

The control unit may control the actuator unit on a real-time basis based on the biometric information continuously received by the communication unit.

The biometric information presentation apparatus may further include a storage unit, and the control unit may cause the storage unit to store the biometric information received by the communication unit, and control the actuator unit in response to the biometric information read from the storage unit.

In accordance with one embodiment of the present invention, a biometric information presentation method includes steps of receiving biometric information, generating a drive control signal controlling a presentation operation in a predetermined mode in response to the received biometric information, and executing an operation responsive to the drive control signal.

In accordance with embodiments of the present invention, the biometric information regarding the subject is transmitted to the biometric information presentation apparatus. The biometric information regarding the subject is stored on the server and the biometric information presentation apparatus downloads the biometric information from the server.

In response to the received biometric information, the biometric information presentation apparatus performs one of the vibration operation, the shape changing operation, the pressure application operation, the temperature changing operation, the moisture changing operation, the displaying operation and the audio output operation. For example, the biometric information presentation apparatus expresses the heart beat or pulse of the subject by vibration, respiration of the subject by a change in the size of a shape, or blood pressure of the subject in the form of pressure application.

A user of the biometric information presentation apparatus can physically feel the biometric information of a well-known person or an acquaintance as a subject by the operation of the biometric information presentation apparatus.

In accordance with embodiments of the present invention, the user of the biometric information presentation apparatus can enjoy a new type of pleasure, namely, physically feeling the biometric information of another person.

### BRIEF DESCRIPTION OF THE DRAWINGS

FIGS. 1A and 1B are block diagrams of biometric information sharing systems in accordance with one embodiment of the present invention;

FIG. 2 is a block diagram illustrating a biometric information detection and transmission apparatus in accordance with one embodiment of the present invention;

FIG. 3 is a block diagram illustrating a biometric information detection and transmission apparatus in accordance with one embodiment of the present invention;

FIG. 4 is a block diagram illustrating a server in accordance with one embodiment of the present invention;

FIG. 5 is a block diagram illustrating a biometric information presentation apparatus in accordance with one embodiment of the present invention;

FIG. 6 is a block diagram illustrating the biometric information presentation apparatus in accordance with one embodiment of the present invention;

FIG. 7 is a flowchart illustrating an upload process in accordance with one embodiment of the present invention;

FIG. 8 illustrates biometric information stored on a server in accordance with one embodiment of the present invention;

FIG. 9 is a flowchart illustrating a download process in accordance with one embodiment of the present invention;

FIGS. 10A-10C are flowcharts illustrating an output process in accordance with one embodiment of the present invention;

FIGS. 11A-11C illustrate display examples based on the biometric information in accordance with one embodiment of the present invention; and

FIG. 12 is a flowchart illustrating a biometric information communication process in accordance with one embodiment of the present invention.

### DESCRIPTION OF THE PREFERRED EMBODIMENTS

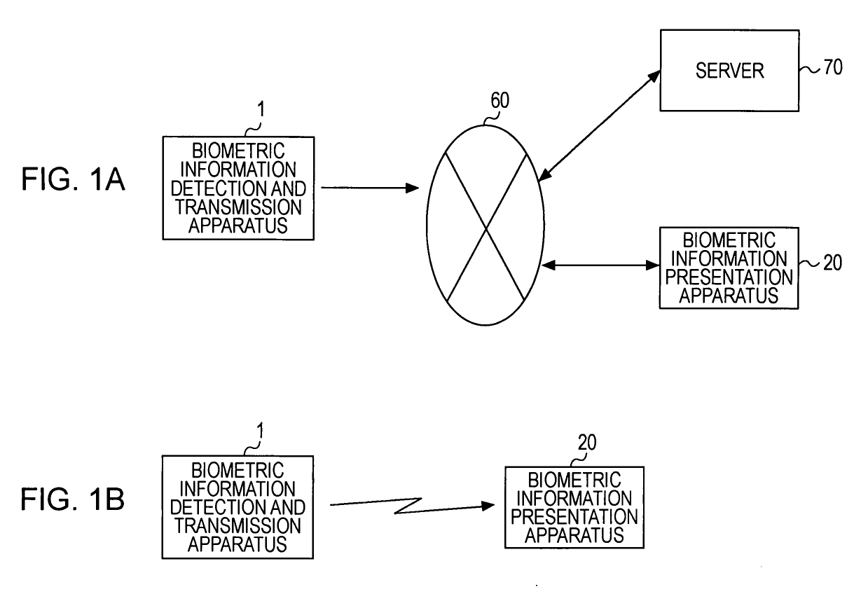

FIGS. 1A and 1B illustrate biometric information sharing systems in accordance with embodiments of the present invention.

In a biometric information detection and transmission apparatus 1 of FIG. 1A, a server 70 and a biometric information presentation apparatus 20 communicate with each other via a network 60.

The network 60 may be one of the Internet, a cellular phone communication system, a personal handyphone system (PHS), an adhoc network, and a local-area network (LAN), for example.

The biometric information detection and transmission apparatus 1 can be mounted on a person (subject) whose biometric information is going to be supplied to another person. The subject may mount the biometric information detection and transmission apparatus 1 on him or her always or during a particular period of time. For example, the subject may mount the biometric information detection and transmission apparatus 1 during a particular occasion different from everyday routine, such as a sporting event, concert, a party or any other event. The subject may mount the biometric information detection and transmission apparatus 1 even in everyday routine, for example, during a commute time, office hours, or sleep time. The subject can thus mount the biometric information detection and transmission apparatus 1 any time when he or she may wish to provide the biometric information to another person.

The biometric information detection and transmission apparatus 1 detects the biometric information regarding the subject. Upload data containing the detected biometric information is generated and then transmitted to the server 70 via the network 60.

The server 70 stores the uploaded biometric information on an internal database thereof. As will be described in detail later, the biometric information is stored with identification information uniquely identifying the subject (hereinafter referred to as subject ID) and date and time information indicating the date and time of the detection of the biometric information (year, month, day, hour, minute and second) associated therewith.

The server 70 can disclose the stored biometric information on a website by downloading the biometric information. In this case, the biometric information may be disclosed with no limitation. Alternatively, the biometric information may be provided to registered users only or may be provided in a pay-based service.

For example, heart beat of Mr. A as an athlete in a game or blood pressure of Mr. B as a singer in a concert may be disclosed with their prior consents.

Any information that identifies a subject may be left undisclosed to the public.

General users may physically experience the disclosed biometric information using the biometric information presentation apparatus 20.

The biometric information presentation apparatus 20 accesses the server 70 (namely, a website managed by the server 70), selects and downloads any part of the disclosed biometric information.

In response to the downloaded biometric information, the biometric information presentation apparatus 20 performs one of a vibration operation, a shape changing operation, a pressure application operation, a temperature changing operation, a moisture changing operation, a displaying operation and an audio output operation. For example, the biometric information presentation apparatus 20 includes, as actuation units, body actuators presenting vibration, pressure, temperature, moisture, and a display and an audio output unit. The body actuator operates in response to the biometric information. For example, the body actuator expresses heart beat or pulse by vibration, respiration by a change in the size of a shape of the actuator, or a blood pressure state by a pressure application.

In this way, the user of the biometric information presentation apparatus can physically feel the biometric information regarding a subject such as a well-known person or an acquaintance by the presentation action of the biometric information presentation apparatus.

As shown in FIG. 1A, the biometric information presentation apparatus 20 allows the user to feel physically the biometric information detected by the biometric information detection and transmission apparatus 1 and transmitted via the network 60 and the server 70. Also, as shown in FIG. 1B, the biometric information detection and transmission apparatus 1 and the biometric information presentation apparatus 20 can directly communicate with each other.

In the system of FIG. 1B, the biometric information detection and transmission apparatus 1 directly communicates with the biometric information presentation apparatus 20. The biometric information detection and transmission apparatus 1 transmits the detected biometric information of the subject to the biometric information presentation apparatus 20. The body actuator in the biometric information presentation apparatus 20 operates in response to the biometric information of the subject. The user of the biometric information presentation apparatus 20 can thus physically feel the biometric information of the subject. For example, one family member may be a subject and another family member may be a user of the biometric information presentation apparatus 20. The user can thus physically experience the biometric information of the subject family member. In one example, the mother as a subject may mount the biometric information detection and transmission apparatus 1 on her and her young child may feel physically the operation of the biometric information presentation apparatus 20 (for example, a vibration responsive to the heart beat of the mother).

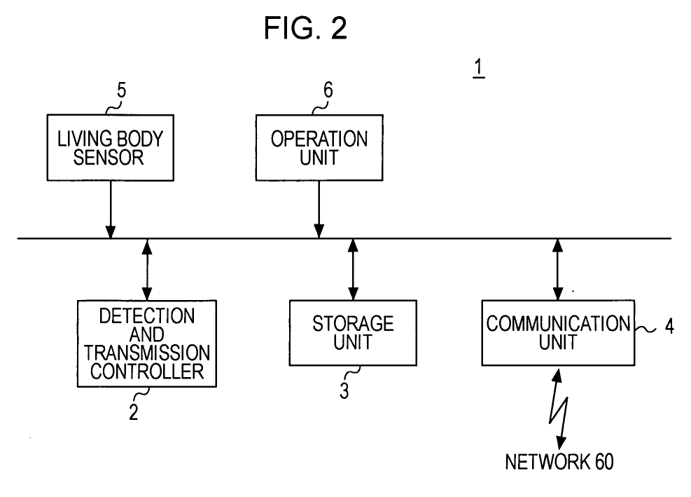

FIG. 2 illustrates the biometric information detection and transmission apparatus 1 in the biometric information sharing system.

As shown in FIG. 2, the biometric information detection and transmission apparatus 1 includes a detection and transmission controller 2, a storage unit 3, a communication unit 4, a living body sensor 5, and an operation unit 6.

The living body sensor 5 detects the biometric information of the subject. The biometric information contains at least one piece of information selected from the group consisting of pulse, heart rate, electrocardiogram, electromyogram, respiration, perspiration, galvanic skin response (GSR), blood pressure, blood oxygen saturation, skin surface temperature, electroencephalogram, blood flow change, body temperature, body motion, head motion, center of gravity, rhythm of walking and running, and the state of the eyes of the subject.

To detect GSR, body temperature, skin surface temperature, electrocardiogram, electromyogram, heart rate, pulse, blood flow, blood pressure, electroencephalogram, perspiration, and body temperature of the subject, sensors placed in contact with the skin of the subject are used. To detect electroencephalogram (brain wave), a sensor mounted in contact with the head of the subject may be used.

A sensor for detecting the state of the eyes of the user, an imaging device for imaging the eyes of the user may be used. The direction of the line of sight, focal length, pupillary opening, eyeground pattern, nictitation of the eyes of the user are detected by analyzing the image of the eyes of the user imaged by the imaging device. The sensor for detecting state of the eyes of the user may include an illumination unit for directing light onto the eyes of the subject and a light receiving unit for receiving light reflected from the eyes. For example, the thickness of the lens of the eye of the subject is detected from the reflected light.

The movement of the body, the movement of the head, the center of gravity of the body, the rhythm of walking or running may be detected using an acceleration sensor or a gyroscope (angular velocity sensor). The acceleration sensor or the gyroscope detects signals responsive to the movement of the subject, thereby detecting the movement of the head, the movement of the body, the movement of an arm, and the movement of a leg of the subject. To detect the movement of the arm or the leg of the subject, the acceleration sensor or the gyroscope may be mounted onto the arm or the leg of the subject.

The living body sensor 5 outputs detection result information supplied from these sensors.

The detection and transmission controller 2 includes a central processing unit (CPU). The detection and transmission controller 2 controls detection of the biometric information and transmission of the detected biometric information.

The storage unit 3 includes memories such as a read-only memory (ROM), a random-access memory (RAM), and a non-volatile memory and works as a program storage area or a work area for the detection and transmission controller 2. The storage unit 3 may be arranged as an internal memory in a microcomputer chip for the detection and transmission controller 2.

The non-volatile memory area of the storage unit 3 may store identification information uniquely identifying an individual biometric information detection and transmission apparatus 1 (device ID), and identification information identifying a subject of the biometric information detection and transmission apparatus 1 (subject ID).

The communication unit 4 performs data communication with an external communication apparatus. In the system of FIG. 1A, the communication unit 4 communicates with the server 70 via the network 60. The communication unit 4 may communicate with the server controller 72 in a wired fashion or a wireless fashion. For example, the communication unit 4 performs wireless communication with a network access point.

In the system of FIG. 1B, the communication unit 4 performs data communication with the biometric information presentation apparatus 20 in a wired or wireless fashion.

The operation unit 6 is used by the user in order to enter instructions required to use the biometric information detection and transmission apparatus 1. For example, the user uses the operation unit 6 to control power, detect the biometric information, and start and end the transmission of the biometric information.

The subject ID identifying the subject and status information may be entered via the operation unit 6. The status information indicates how the subject acts during the detection of the biometric information. More specifically, the status information indicates the status of the subject at the detection of the biometric information. The subject may be participating in any particular sporting game, in concert, or in performance, or viewing a play or a game, sleeping, or in one of everyday routines.

The detection and transmission controller 2 in the biometric information detection and transmission apparatus 1 stores on the storage unit 3 values of the biometric information of the subject detected by the living body sensor 5. For example, in response to an operational input from the operation unit 6, the detection and transmission controller 2 captures the value of the biometric information within a period of time from the start to the end of detection, or a predetermined period of time starting from the start of detection, and stores the captured values of the biometric information onto the storage unit 3.

The detection and transmission controller 2 transmits the biometric information from the storage unit 3. In response to an operational input onto the operation unit 6 or automatically, the detection and transmission controller 2 generates upload data containing the biometric information and causes the communication unit 4 to transmit the upload data to the server 70 via the network 60 (or to the biometric information presentation apparatus 20 as shown in FIG. 1B). The upload data may contain not only the biometric information but also the subject ID, the device ID and the status information. The detection and transmission controller 2 may count date and time, and contains the corresponding date and time information in the biometric information.

The detection and transmission controller 2 may cause the biometric information detected by the living body sensor 5 to be transmitted to an external apparatus on a real-time basis. More specifically, the detection and transmission controller 2 transfers the biometric information detected by the living body sensor 5 to the communication unit 4 and causes the communication unit 4 to process the biometric information, for example, to modulate the biometric information and then to transmit the processed biometric information to the external apparatus (such as one of the server 70 and the biometric information presentation apparatus 20).

The biometric information detection and transmission apparatus 1 is preferably compact enough to be mounted on the subject. A portion of the biometric information detection and transmission apparatus 1 (for example, the living body sensor 5) is mounted in touch with the skin, the head, or any other portion of the subject depending on information to be picked up. For example, the biometric information detection and transmission apparatus 1 may be implemented in the form of a wrist-watch, glasses, a headset, a cap, a hard hat, or a glove, or may be attached to clothes.

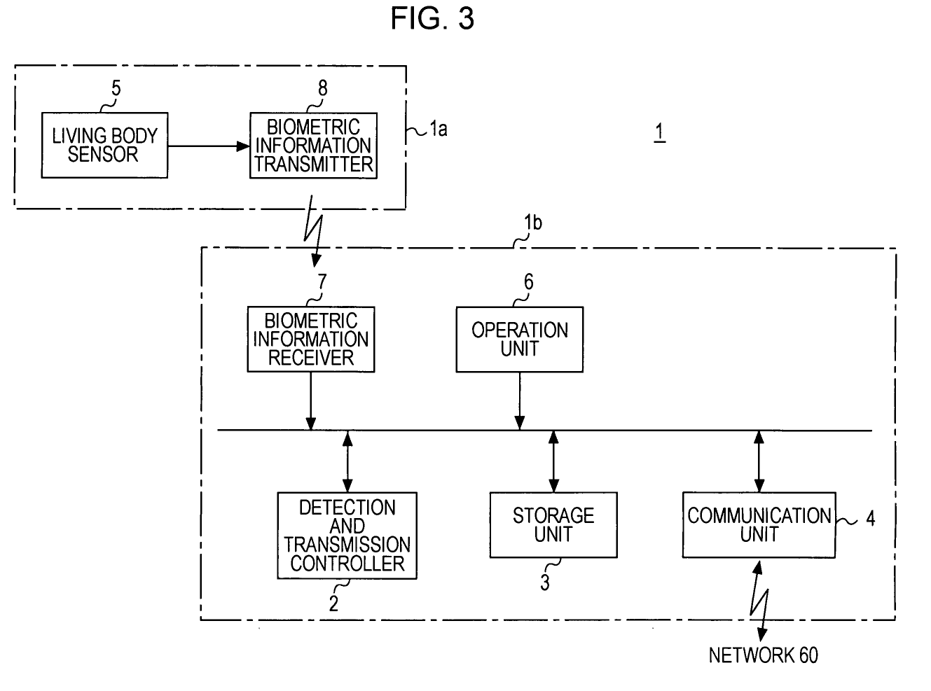

FIG. 3 illustrates another example of the biometric information detection and transmission apparatus 1. The biometric information detection and transmission apparatus 1 includes a detector 1a and a transmitter 1b.

The detector 1a includes a living body sensor 5, and a biometric information transmitter 8. The transmitter 1b includes a detection and transmission controller 2, a storage unit 3, a communication unit 4, an operation unit 6, and a biometric information receiver 7.

The biometric information receiver 7 communicates with the biometric information transmitter 8 in one of a wireless fashion and a wired fashion. If wireless communication is used, a short-range wireless communication method such as Bluetooth may be used. Optical data communication based on optical pulse modulation in visible light range or non-visible light range may also be used. One of a long-range radio communication and a network communication may also be used.

As shown in FIG. 3, the biometric information detected by the living body sensor 5 is transmitted from the biometric information transmitter 8 and then received at the biometric information receiver 7.

The detection and transmission controller 2 stores on the storage unit 3 the biometric information received at the biometric information receiver 7 or causes the communication unit 4 to transmit the received biometric information to the external apparatus (such as one of the server 70 and the biometric information presentation apparatus 20).

As shown in FIG. 3, only the detector 1a is simply mounted in touch with the skin or the head of the subject. The light-weight detector 1a is easy to carry. Compact and light-weighted design is easy to implement because the detector 1a has a simple structure containing the living body sensor 5 and the biometric information transmitter 8. As a result, the detector 1a can be conveniently mounted on any portion of the body of the subject.

The transmitter 1b may be a dedicated compact device held by the subject. Alternatively, the function of the transmitter 1b may be integrated into a mobile device such as a cellular phone or a personal digital assistant (PDA). Considering that transmitter 1b is not necessarily held by or mounted on the subject, a modestly large sized transmitter 1b is perfectly acceptable. A desk-top personal computer or a note-book personal computer may incorporate the function of the transmitter 1b.

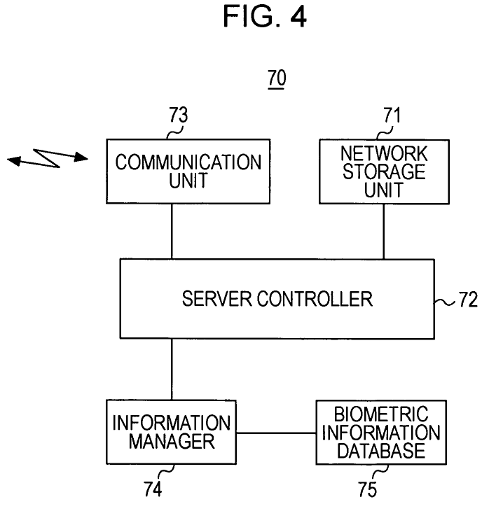

FIG. 4 illustrates the server 70.

The server 70 stores the biometric information uploaded from the biometric information detection and transmission apparatus 1 via the network 60, and downloads the stored biometric information to the biometric information presentation apparatus 20.

The server 70 includes a network storage unit 71, a server controller 72, a communication unit 73, an information manager 74, and a biometric information database 75.

The server controller 72 generally controls the server 70. More specifically, the server controller 72 controls a network communication process, an upload process of the biometric information from the biometric information detection and transmission apparatus 1, management of a network website, and a download process of the biometric information to the biometric information presentation apparatus 20.

The network storage unit 71 may include a hard disk drive (HDD), for example. The network storage unit 71 stores temporarily data to be transmitted to or received from each of the biometric information detection and transmission apparatus 1 and the biometric information presentation apparatus 20 via the network 60 (upload data and download data) and also stores a website image.

The communication unit 73 communicates data with each of the biometric information detection and transmission apparatus 1 and the biometric information presentation apparatus 20 via the network 60.

The information manager 74 manages the biometric information uploaded from the biometric information detection and transmission apparatus 1.

The biometric information database 75 stores in the form of a database the uploaded biometric information with the subject ID, the status information and the date and time information associated therewith.

The information manager 74 registers and searches the biometric information on the biometric information database 75 and also generates and registers the subject ID and the status information on the biometric information database 75.

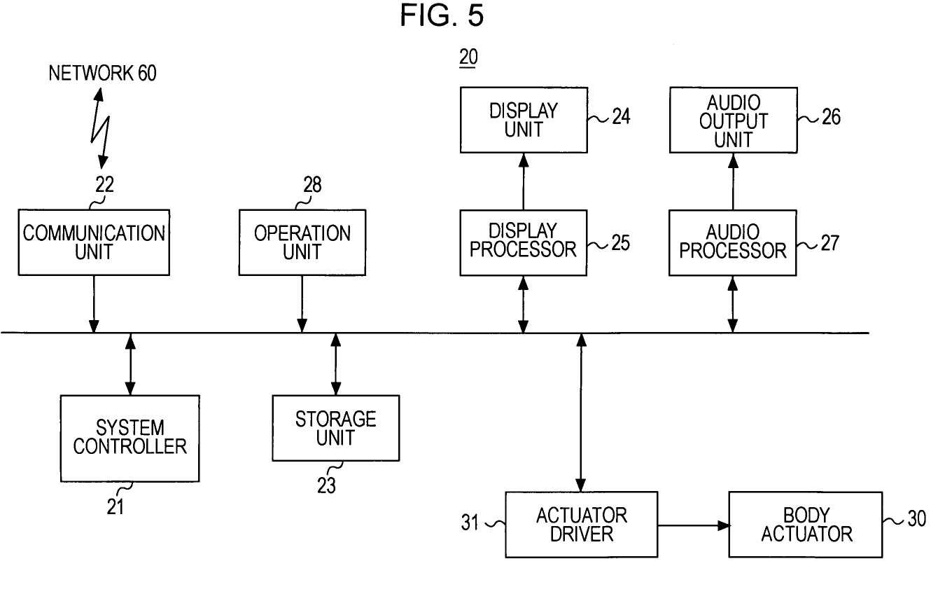

FIG. 5 illustrates the biometric information presentation apparatus 20.

The biometric information presentation apparatus 20 includes a system controller 21, a communication unit 22, a storage unit 23, a display 24, a display processor 25, an audio output unit 26, an audio processor 27, an operation unit 28, a body actuator 30 and an actuator driver 31.

The system controller 21 is a microcomputer. The microcomputer includes a central processing unit (CPU), a read-only memory (ROM), a random-access memory (RAM), a non-volatile memory, and an interface. The system controller 21 generally controls the biometric information presentation apparatus 20.

The system controller 21 controls each element in the biometric information presentation apparatus 20, thereby performing a communication process and a process responsive to the biometric information in accordance with an operation program stored therewithin.

The communication unit 22 exchanges data with the external apparatus. The communication unit 22 performs data communication with the server 70 via the network 60 of FIG. 1A, thereby receiving the biometric information. The communication unit 22 may simply perform one of wired and wireless communications in a network connection. As in the system of FIG. 1B, the communication unit 22 may perform one of wired and wireless communications with the communication unit 4 in the biometric information detection and transmission apparatus 1, thereby receiving the biometric information.

The storage unit 23, controlled by the system controller 21, records the received biometric information. The storage unit 23, controlled by the system controller 21, also read the recorded biometric information.

The storage unit 23 may include a solid-state memory such as a RAM or a flash memory, or a hard disk drive (HDD).

The storage unit 23 may be a recording and reproducing drive instead of the built-in recording medium. One of mobile recording media, including a memory card, an optical disk, a magnetic optical disk, and a hologram memory, may be loaded on such a recording and reproducing drive.

The biometric information presentation apparatus 20 may include both the built-in type memory such as a solid-state memory or a HDD and the recording and reproducing drive driving the mobile recording medium.

The display 24 includes a display panel such as a liquid-crystal display panel or an organic electroluminescence (EL) panel and a display driver for driving the display panel. The display driver includes a pixel drive circuit for displaying, on the display panel, image data supplied from the display processor 25. The display drive circuit supplies to each of pixels arranged in a matrix on the display panel a drive signal responsive to a video signal supplied at predetermined horizontal and vertical driving timings, thereby displaying an image on the display panel.

The display processor 25, controlled by the system controller 21, drives the pixel drive circuit in the display 24 and displays a predetermined image on the display panel. The system controller 21 generates image data based on the biometric information and then supplies the generated image data to the display processor 25. The display processor 25 processes the image data to be displayed on the display 24.

The image data based on the biometric information refers to an image representing the biometric information, a graphical image, and characters.

During communication with the server 70, the display 24 also displays a website page provided by the server 70.

The audio processor 27 includes an audio signal processor and an amplifier. The audio output unit 26 includes a loudspeaker and an earphone, for example.

The system controller 21 generates an audio signal based on the biometric information. The audio signal is supplied to the audio processor 27 and then output from the audio output unit 26. For example, the system controller 21 generates an audio sound such as a cardiac sound in response to the heart rate information and the pulse information, and the cardiac sound is then output from the audio output unit 26.

The operation unit 28 is operated by the user. For example, the user operates the operation unit 28 to download the biometric information, to output information based on the biometric information, and switch on and off the biometric information presentation apparatus 20.

The system controller 21 performs control process in response to operational information input on the operation unit 28 by the user.

The body actuator 30 functions as one of a vibrator, a pressure applier, a shape changer, a temperature changer, and a moisture changer.

The body actuator 30 performs a predetermined operation in response to a drive signal supplied from the actuator driver 31. The system controller 21 supplies the actuator driver 31 with a drive control signal based on the biometric information. In response to the drive control signal based on the biometric information, the actuator driver 31 drives the body actuator 30.

In this way, the idea of vibration responsive to heart beat and a pressure application responsive to blood pressure are thus implemented.

The user can thus physically feel vibration, pressure, shape change, temperature change and moisture change based on the biometric information when the body actuator 30 operates.

The body actuator 30 will be specifically described later.

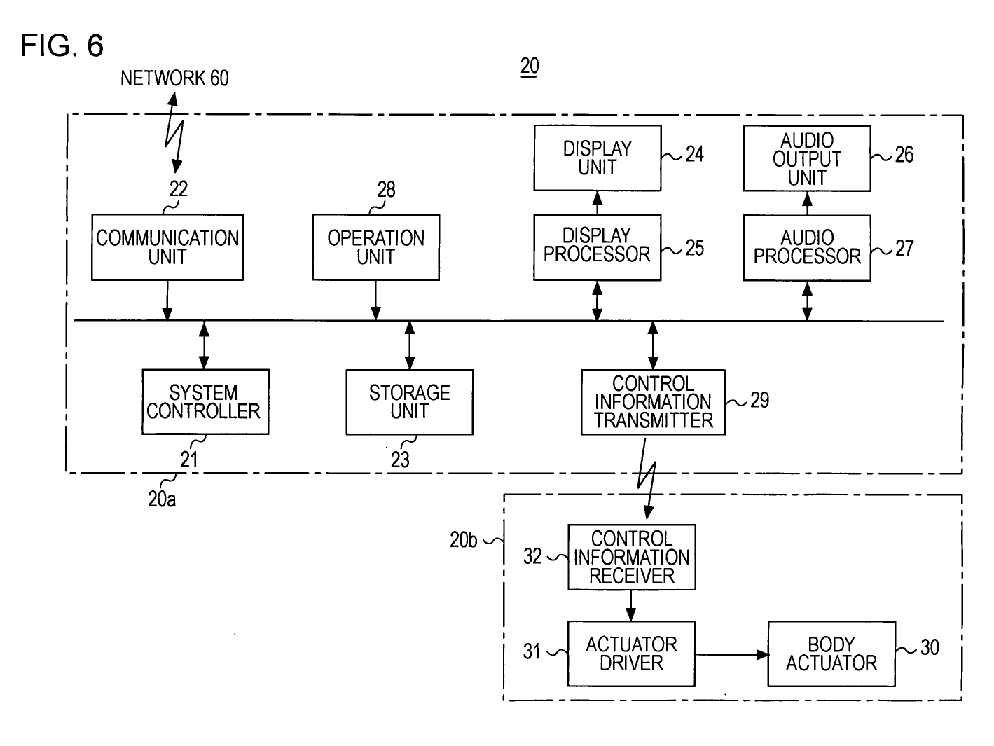

FIG. 6 illustrates another example of the biometric information presentation apparatus 20. The biometric information presentation apparatus 20 includes a terminal 20a and an actuator 20b as separate units.

The terminal 20a includes a control information transmitter 29 in addition to the system controller 21, a communication unit 22, the storage unit 23, the display 24, the display processor 25, the audio output unit 26, an audio processor 27, the operation unit 28.

The actuator 20b includes a control information receiver 32 in addition to the body actuator 30, and the actuator driver 31.

The control information transmitter 29 and the control information receiver 32 communicate with each other in a wired fashion or a wireless fashion. If wireless communication is used, a short-range wireless communication method such as Bluetooth may be used. Optical data communication based on optical pulse modulation in visible light range or non-visible light range may also be used. One of a long-range radio communication and a network communication may also be used.

As shown in FIG. 6, the system controller 21 causes the control information transmitter 29 to transmit a drive control signal based on the biometric information. The drive control signal is received at the control information receiver 32 and transferred to the actuator driver 31. The actuator driver 31 drives the body actuator 30 in response to the drive control signal.

As shown in FIG. 6, the user can physically feel an actuation responsive to the biometric information, holding or using the actuator 20b.

The terminal 20a may be a standalone unit or may be integrated into a personal computer.

The biometric information detection and transmission apparatus 1, the server 70, and the biometric information presentation apparatus 20 have been discussed for exemplary purposes only. Elements may be added to or deleted from these devices depending on an operation actually performed or a function actually implemented.

Operation of the biometric information sharing system of FIG. 1A including the biometric information detection and transmission apparatus 1, the server 70, and the biometric information presentation apparatus 20 is described below.

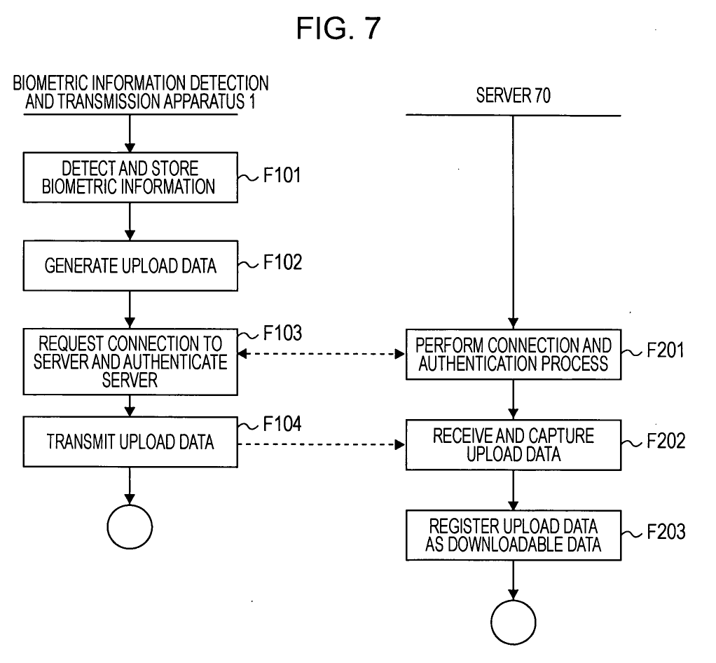

FIG. 7 illustrates an upload process of the biometric information to be uploaded from the biometric information detection and transmission apparatus 1 to the server 70. As shown in FIG. 7, the process of the biometric information detection and transmission apparatus 1 is controlled by the detection and transmission controller 2 and the process of the server 70 is controlled by the server controller 72.

In step F101, the biometric information detection and transmission apparatus 1 detects and then stores the biometric information of the subject. More specifically, for a predetermined period of time, the detection and transmission controller 2 monitors the biometric information detected by the living body sensor 5 and then stores the biometric information onto the storage unit 3.

In step F102, the biometric information detection and transmission apparatus 1 uploads the biometric information. The detection and transmission controller 2 sets part or whole of the biometric information stored on the storage unit 3 as upload data. The upload data may contain the subject ID, the status information and the date and time information of detection of the biometric information.

In step F103, the biometric information detection and transmission apparatus 1 communicates with the server 70. The detection and transmission controller 2 causes the communication unit 4 to start network communication with the server 70. In step F201, the server controller 72 in the server 70 causes the communication unit 73 to perform a communication connection process and an authentication process. A variety of authentication processes may be used. For example, the biometric information detection and transmission apparatus 1 transmits a device ID and the server 70 determines whether the device ID is authentic and appropriately registered one.

If the authentication process has been successfully completed, the biometric information detection and transmission apparatus 1 performs an upload process. The detection and transmission controller 2 causes the communication unit 4 to transmit the upload data containing the biometric information.

In step F202, the server controller 72 in the server 70 stores the upload data received by the communication unit 73 onto the network storage unit 71.

When the upload process is complete, the server controller 72 performs a decode process and a data extraction process on the upload data in step F203. The server controller 72 supplies the biometric information contained in the upload data to the information manager 74. The server controller 72 then registers the biometric information as downloadable data onto the biometric information database 75.

In this way, the biometric information database 75 in the server 70 accumulates the uploaded biometric information.

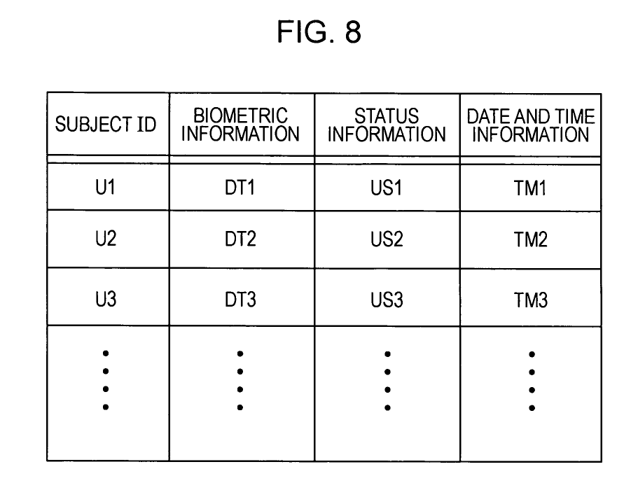

FIG. 8 illustrates a registration format of the biometric information database 75.

As shown in FIG. 8, uploaded biometric information DT1, DT2, DT3, . . . are associated with the subject ID (U1, U2, U3, . . . ) and, the status information (US1, US2, US3, . . . ), the date and time information (TM1, TM2, TM3, . . . ), respectively.

The subject ID is identification information of the subject from whom the biometric information has been detected. If the subject ID is contained in the upload data, the subject ID extracted from the upload data may be registered. For example, when the biometric information DT1 is uploaded, the subject ID “U1” may be transmitted together with the biometric information DT1 from the biometric information detection and transmission apparatus 1. The server 70 extracts the subject ID “U1” from the upload data and associates the biometric information DT1 with the subject ID “U.” Similarly, the status information and the date and time information, if contained in the upload data, are extracted and registered with the biometric information associated therewith.

Even if the subject ID and the status information are not contained in the upload data, these pieces of information may be generated and registered on the server side.

An operator of the server 70 may ask a particular person to provide his or her own biometric information. The particular person as a subject may use the biometric information detection and transmission apparatus 1 and then upload the biometric information. The server 70 can then identify the particular person. In such a case, the subject ID corresponding to the uploaded biometric information may be input on the side of the server 70.

The same is true of the status information. For example, a sport athlete may be requested to provide his or her biometric information during a particular sporting game the athlete participates. The status information indicating the phase of the sporting game and the type of the game may be input on the side of the server 70.

If the biometric information detection and transmission apparatus 1 is continuously used by a particular person, the subject is identified by the device ID. The subject ID may be automatically determined based on the device ID or the subject ID may be entered.

The biometric information may be registered with the device ID (instead of or together with the subject ID) associated therewith.

The biometric information presentation apparatus 20 can download the biometric information accumulated on the server 70.

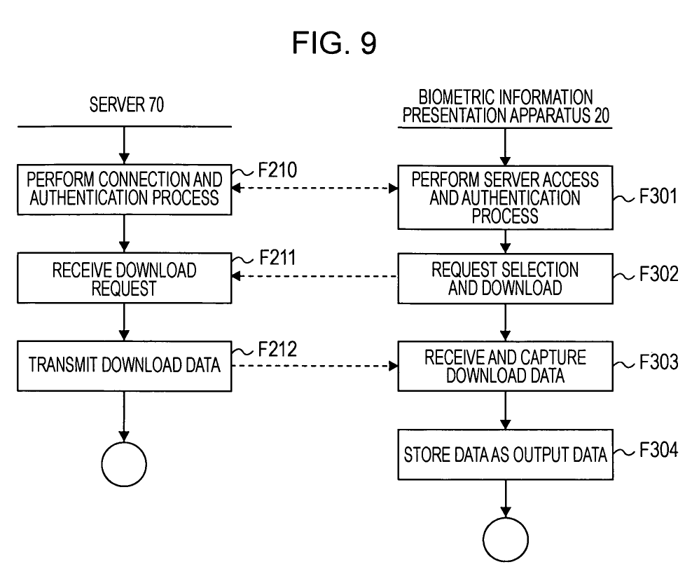

FIG. 9 illustrates a download process of the biometric information from the server 70 to the biometric information presentation apparatus 20. The process of the server 70 is controlled by the server controller 72 and the process of the biometric information presentation apparatus 20 is controlled by the system controller 21.

To download the biometric information, the biometric information presentation apparatus 20 performs a communication connection process with the server 70 in step F301. The system controller 21 causes the communication unit 22 to start network communication with the server 70. In step F210, the server controller 72 in the server 70 causes the communication unit 73 to perform a connection establishment process and an authentication process. A variety of authentication processes are contemplated. For example, the user of the biometric information presentation apparatus 20 enters a user ID and a login password, and the server 70 checks the user ID and the login password. If the authentication process has been successfully completed, the server 70 permits the biometric information presentation apparatus 20 to access a download website. The user of the biometric information presentation apparatus 20 can view the website.

The server 70 displays on the website a list of biometric information registered as downloadable on the biometric information database 75. The biometric information is preferably displayed is in an easy-to-view manner in accordance with the subject ID and the status information. For example, the biometric information regarding Mr. A as a sporting athlete may be labeled as “heart rate of Mr. A during match.”

The user of the biometric information presentation apparatus 20 views the download website page, selects the biometric information the user may wish to experience, and requests the server 70 to download the selected biometric information. In step F302, the system controller 21 transmits to the server 70 a download request requesting the biometric information selected by the user.

In step F211, the server controller 72 detects that the download request has been received. In step F212, the server controller 72 downloads the biometric information. More specifically, the server controller 72 causes the information manager 74 to read the requested biometric information from the biometric information database 75. The server controller 72 generates the download data containing the biometric information and then downloads the download data from the communication unit 73.

In step F303, the system controller 21 in the biometric information presentation apparatus 20 receives and captures the biometric information. In step F304, the system controller 21 causes the storage unit 23 to store the captured download data.

In this way, the user of the biometric information presentation apparatus 20 has downloaded the biometric information selected by the user onto the biometric information presentation apparatus 20. The biometric information presentation apparatus 20 can perform a variety of actuation motions using the download data.

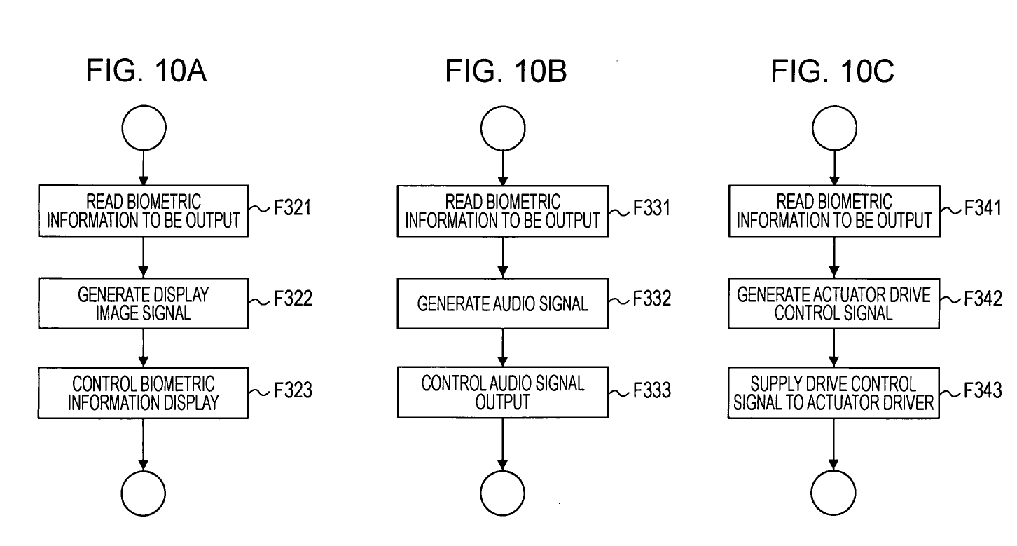

FIGS. 10A-10C illustrate a variety of presentation operations.

FIG. 10A illustrates a display operation performed by the biometric information presentation apparatus 20 in response to the biometric information.

In step F321, the system controller 21 reads biometric information to be displayed, out of the biometric information downloaded and stored on the storage unit 23. The system controller 21 causes the storage unit 23 to read the biometric information and captures data of the biometric information. In step F322, the system controller 21 generates a display screen signal in response to the data of the biometric information. For example, the system controller 21 generates an image signal for an image, graphs, and tables representing the biometric information.

In step F323, the system controller 21 supplies the display screen signal to the display processor 25 and causes the display processor 25 to display the biometric information on the display 24.

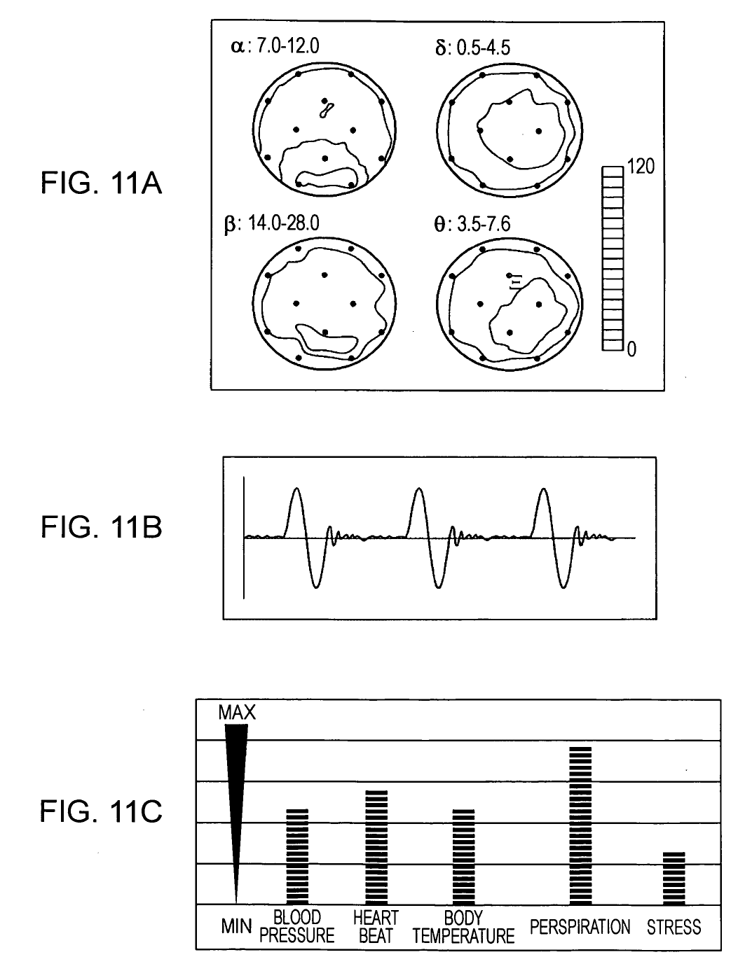

FIGS. 11A-11C illustrate displayed images.

FIG. 11A is an image of the biometric information. Alpha (α) wave, beta (β) wave, theta (θ) wave, and delta (δ) wave are activated in sites and amplitudes as shown in FIG. 11A. In this way, the biometric information is graphically displayed together with an image of a part of the subject body such as a brain image and a body activity is diagrammatically displayed.

FIGS. 11B and 11C are graphical plots of the biometric information. FIG. 11B is a waveform diagram of the heart beat or pulse. FIG. 11C is a graph plotting in values the blood pressure, heart rate, body temperature, perspiration and stress of the subject.

The display 24 displays such an image so that the user may view the downloaded biometric information of another person.

FIG. 10B illustrates an audio output process of the biometric information presentation apparatus 20 that outputs an audio sound in response to the biometric information.

In step F331, the system controller 21 reads a portion of the biometric information to be output, of the biometric information downloaded and stored on the storage unit 23. More specifically, the system controller 21 causes the storage unit 23 to read the biometric information and captures data of the biometric information.

In step F332, the system controller 21 generates an audio signal in response to the data of the biometric information. For example, the audio signal is generated as a heart sound responsive to the heart beat as the biometric information.

In step F333, the system controller 21 supplies the audio signal to the audio processor 27 so that the audio output unit 26 outputs an corresponding sound.

The audio output unit 26 outputs the corresponding sound and the user hears the sound responsive to the downloaded biometric information of another person.

FIG. 10C illustrates a process of the body actuator 30 the biometric information presentation apparatus 20 drives in response to the biometric information.

In step F341, the system controller 21 reads a portion of biometric information to be used to drive the body actuator 30, of the biometric information downloaded and stored on the storage unit 23. More specifically, the system controller 21 causes the storage unit 23 to read the biometric information and captures the biometric information.

In step F342, the system controller 21 generates a drive control signal of the body actuator 30 based on data of the biometric information. For example, the system controller 21 generates the drive control signal indicating a change of an intensity level (drive level) responsive to the heart beat as the biometric information.

In step F343, the system controller 21 supplies the drive control signal to the actuator driver 31, thereby driving the body actuator 30.

With the body actuator 30 driven, the user can physically feel the downloaded biometric information of another person in the form of vibration, shape change, pressure change, temperature change, and moisture change. The operation of the body actuator 30 will be specifically described later.

The processes discussed with reference to FIGS. 7, 9 and 10A-10C are performed in conjunction with the server 70 as shown in FIG. 1A. As shown in FIG. 1B, the biometric information detection and transmission apparatus 1 may directly transmit the biometric information to the biometric information presentation apparatus 20.

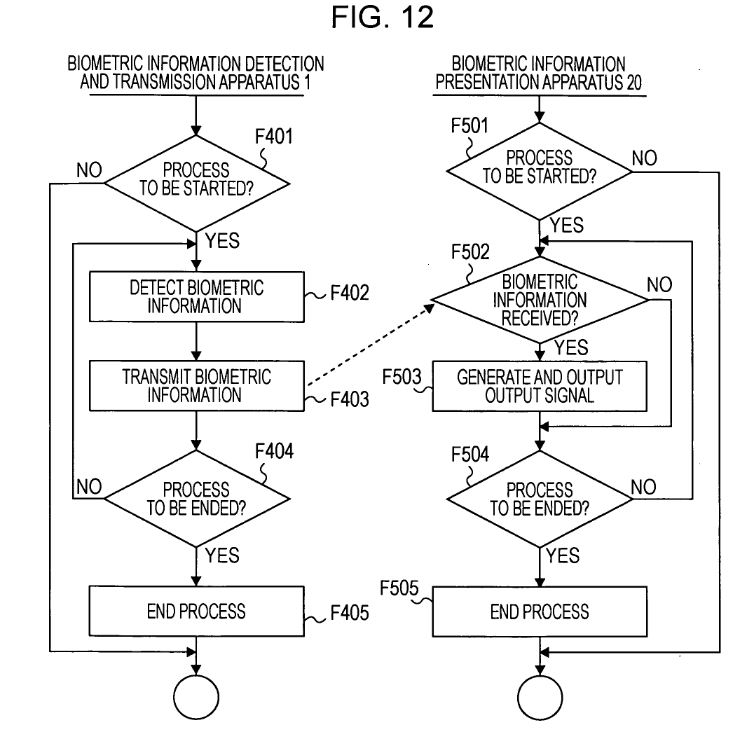

FIG. 12 illustrates a process of the detection and transmission controller 2 in the biometric information detection and transmission apparatus 1 and a process of the system controller 21 in the biometric information presentation apparatus 20.

The detection and transmission controller 2 in the biometric information detection and transmission apparatus 1 proceeds from step F401 to step F402 in response to the generation of a process start trigger. The process start trigger may be generated at the moment power is on, or may be generated by the subject.

In step F402, the biometric information is detected. The detection and transmission controller 2 captures a detection signal of the biometric information supplied from the living body sensor 5.

In step F403, the system controller 21 transfers the captured biometric information as transmission data to the communication unit 4, and causes the communication unit 4 to perform a predetermined modulation operation on the transmission data, and to transmit the modulated transmission data.

The detection and transmission controller 2 cycles through steps F402 and F403 until a process end trigger (such as a switch-off operation or a user end operation) is detected in step F404. Until the process end, the biometric information detected by the living body sensor 5 is continuously transmitted to the biometric information presentation apparatus 20 on a real-time basis.

At the moment the process end trigger is generated, the biometric information presentation apparatus 20 proceeds from step F404 to step F405 in order to perform an operation stop process to stop detection and transmission (or a power-off process).

In response to a process start trigger (for example, a power-on operation or a start operation), the system controller 21 in the biometric information presentation apparatus 20 proceeds from step F501 to step F502.

In step F502, the system controller 21 monitors reception of the biometric information. When the communication unit 22 detects the reception of the biometric information from the biometric information detection and transmission apparatus 1, the system controller 21 controls generation of an output signal and output of the outputting of the output signal in step F503.

More specifically, step F503 is identical to control processes discussed with reference to FIGS. 10A-10C. For example, in the case of the display output operation, a display screen signal is generated in response to the received biometric information and then displayed on the display 24. In the case of the audio output operation, the audio signal is generated in response to the received biometric information and then output from the audio output unit 26. In the case of driving the body actuator 30, the drive control signal is generated in response to the received biometric information, and the actuator driver 31 drives the body actuator 30 in accordance with the generated drive control signal.

The system controller 21 cycles through step F502 and step F503 until a process end trigger is detected in step F504. Until the process end process, the body actuator 30 continuously performs one of the display output operation, the audio output operation and the actuation operation of the body actuator 30 in response to the received biometric information.

The system controller 21 determines that a process end trigger is generated when a power-off operation or an end operation is performed or when the biometric information presentation apparatus 20 has ceased receiving biometric information for a predetermined period of time.

In response to the generation of the process end trigger, the system controller 21 proceeds from step F504 to step F505 to perform an operation control end process (or a power-off process).

With such a system operation, the user of the biometric information presentation apparatus 20 can physically feel, on a real-time basis, the biometric information of the subject who mounts the biometric information detection and transmission apparatus 1 on him or her.

The biometric information is described in detail below.

The biometric information contains at least one piece of information selected from the group consisting of pulse, heart rate, an electrocardiogram signal, electromyogram, respiration (respiratory rate, respiratory depth, respiratory amount), perspiration, galvanic skin response (GSR), blood pressure, blood oxygen saturation (SpO₂), skin surface temperature, electroencephalogram (alpha wave, beta wave, theta wave and delta wave), blood flow change (such as change in cerebral blood flow or peripheral blood flow detected through near-infrared spectroscopy), body temperature, body motion (yawing), head motion (swing), center of gravity, rhythm of walking and running, and the state of the eyes (papillary state, movement of eyes, and nictitation of the eyes).

These pieces of information serve as an indicator of the body status of the user. The biometric-information sharing system of one embodiment of the present invention detects any of these pieces of biometric information or several pieces of biometric information in combination and the user of the biometric information presentation apparatus 20 can feel the actuation operation based on the biometric information.

Types of the biometric information and underlying technologies are listed below. In particular, the biometric information related to the central nerve system, automatic nerve system, visual nerve system, and somatic nervous system are listed. Also listed are physical quantities and measured quantities of detected information, underlying technologies used in measurement, and application examples of the biometric information.

### (1) Central Nerve System 1: Electroencephalography (EEG)

### (a) Physical Quantities and Measured Quantities

Frequency (alpha (α), beta (β), theta (θ) and delta (δ) waves)

Amplitude (Fmtheta wave)

Active sites of alpha, beta, theta, and delta waves

Activation rate (alpha wave, etc.)

Event-related potential (ERP)

### (b) Underlying Technologies

Frequency analysis

Time-series analysis

Autocorrelation and mutual correlation

### (c) Application Examples

Estimation of alertness level (tension and excitement, and attention and concentration)

Analysis of psychological state (emotion spectrum analysis method (ESAM))

Response in somatic activity responsive to stimulus

Bio-feedback (using fluctuations in alpha wave)

Psychotherapy

### (2) Central Nerve System 2: Magnetic Encephalography (MEG)

### (a) Physical Quantities and Measured Quantities

Frequency (alpha (α), beta (β), theta (θ) and delta (δ) waves, etc.)

Active sites of alpha, beta, theta, and delta waves

Event-related potential (ERP)

### (b) Underlying Technologies

Frequency analysis

Time-series analysis

Inverse problem (dipole estimation)

### (c) Application Examples

Identification of active sites in brain
Event-related magnetic field
Analysis of brain function such as memory and language
Function mapping of cerebral cortex
   (3) Central Nerve System 3: Functional Magnetic Resonance Imaging (fMRI)

### (a) Physical Quantities and Measured Quantities

Frequency (alpha (α), beta (β), theta (θ) and delta (δ) waves, etc.)

Active sites of alpha, beta, theta, and delta waves

Event-related potential (ERP)

### (b) Underlying Technologies

Time-series analysis

Mutual correlation

### (c) Application Examples

Analysis of brain function
Visual and spatial attention, visual image
Color sensing
Language and exercise

### (4) Automatic Nerve System 1: Heart and Circulatory System (Electrocardiogram and Heart Rate)

### (a) Physical Quantities and Measured Quantities

Frequency (R-R interval of heart rate, fluctuations in heart rate, and pulse)

Amplitude (pulse and heart rate)

Waveform (pulse and heart rate)

### (b) Underlying Technologies

Frequency analysis, fast Fourier transform (FFT), maximum entropy method (MEM), and wavelet analysis

Time-series analysis

### (c) Application Examples

Estimation of tension and relaxation

Estimation of emotional state

Analysis of function of sympathetic nerve and vagus nerve

### (5) Automatic Nerve System 2: Respiratory System (Respiratory Activity)

### (a) Physical Quantities and Measured Quantities

Frequency (respiratory rate)

Amplitude (respiratory depth)

Waveform (respiratory curve)

Respiratory amount (respiratory exchange ratio, gas exchange ratio)

### (b) Underlying Technologies

Frequency analysis

Time-series analysis

Cycle analysis method

### (c) Application Examples

Estimation of tension and relaxation

Detection of deceit

Relaxation (deep breathing, and regulation of respiration)

### (6) Automatic Nerve System 3: Electrodermal Response (Perspiration Due to Psychological Effect)

### (a) Physical Quantities and Measured Quantities

Response amplitude

Waveform (response varying with time)

Frequency of occurrence

### (b) Underlying Technologies

Frequency analysis

Time-series analysis

### (c) Application Examples

Detection of fear and anxiety

Estimation of alertness level

### (7) Automatic Nerve System 4: Biothermal System (Skin Temperature)

### (a) Physical Quantities and Measured Quantities

Skin temperature

Temperature distribution

### (b) Underlying Technologies

Frequency analysis

Time-series analysis

### (c) Application Examples

Estimation of emotional state
Anxiety, embarrassment, anger (drop in skin temperature of fingers)
Relief and relaxation (rise in skin temperature of fingers)

Estimation of psychological burden
Drop in skin temperature of fingers and nose

### (8) Somatic Nervous System (Electromyogram)

### (a) Physical Quantities and Measured Quantities

Frequency

Amplitude

Waveform

### (b) Underlying Technologies

Frequency analysis

Time-series analysis

### (c) Application Examples

Estimation of alertness state

Estimation of tension and relaxation

Study of facial expression, action and exercise

Rehabilitation therapy (biofeedback)

### (9) Visual Nerve System (Eye Movement, Papillary Opening, Nictitation)

### (a) Physical Quantities and Measured Quantities

Frequency

Amplitude (response amplitude)

Waveform (reaction potential, duration, and stationary time)

Frequency of occurrence (saccadic eye movement, and nictitation)

### (b) Underlying Technologies

Frequency analysis

Time-series analysis

### (c) Application Examples

Estimation of alertness state

Estimation of interest

Estimation of psychological burden

As described above, the biometric information presentation apparatus 20 drives the body actuator 30 in response to the biometric information, thereby allowing the user to experience the biometric information of another person.

The body actuator 30 may be housed in an actuating device and the user may feel the biometric information using the actuating device.

A variety of actuating devices containing the body actuator 30 are contemplated. Typical actuating devices are described below.

### Vibration Devices

Vibration devices with a vibration actuator as the body actuator 30 contained therewithin causes the user to feel vibration.

The vibration devices may include a vibrating ball, a vibrating chair, and a vibrating head. The vibrating ball includes a ball body made of rubber, resin, or the like and a vibration actuator contained in the ball body. The entire ball body is vibrated by the vibration actuator. The user can physically feel vibration by holding the vibrating ball by a hand. In this case, the vibration represents the heart beat or pulse of the subject.

Each of the vibrating chair and the vibrating head includes a vibrating actuator inside and provides vibration responsive to the biometric information of the subject to a person who is sitting or lying down.

The vibration device providing vibration to the user may be configured in a variety of other shapes and mode of operations.

### Shape Changing Devices

Shape changing devices may be made of an elastic material such as a rubber or sponge and configured in a ball shape or a bag-like shape or any other shape.

The body actuator 30 may move an internal supporting structure within the shape changing device to change the shape of the device. Alternatively, the body actuator 30 may suck in air into or discharge air out of the bag-like shape changing device to change the device.

For example, a device that changes the shape thereof in response to respiration or brain wave of the subject may be used.

### Pressure Applying Device

A variety of pressure applying devices for applying pressure to the user are contemplated. For example, a pressure applying device may be configured in a glove-like shape, a band-like shape to be wrapped around an arm or a leg of the user, a clothes-like shape, or a bracelet-like shape.

Pressure responsive to the biometric information such as blood pressure, brain wave, stress, etc. of the subject is thus applied to the user.

### Temperature Changing Devices

A variety of temperature changing devices are contemplated. For example, a temperature changing device may be configured in a ball-like shape or any other shape to be held by a hand of the user. Alternatively, a temperature changing device may be configured in a band-like shape to be wrapped around a hand, a leg, or the body of the user. The user then feels a change in temperature.

The actuator for warming or cooling is arranged within the device and changes the temperature thereof in response to the information of the body temperature or the brain wave of the subject as the biometric information. The user thus feels a temperature change.

### Moisture Changing Devices

A variety of temperature changing devices are contemplated. For example, a moisture changing device may be configured in a ball-like shape or any other shape to be held by a hand of the user. Alternatively, a moisture changing device may be configured in a band-like shape to be wrapped around a hand, a leg, or the body of the subject. The user then feels a change in moisture.

The actuator for moisture addition or drying is arranged within the device and changes the moisture thereof in response to the information of the perspiration or the brain wave of the subject as the biometric information. The user thus feels a moisture change.

Various devices have been discussed for exemplary purposes only. The actuating devices allowing the user to feel physically a variety of biometric information are configured in a variety of shapes and modes of operations.

The user of the biometric information presentation apparatus 20 can thus enjoy a new type of pleasure of feeling physically the biometric information of another person.

The server 70 stores a variety of biometric information of a variety of persons in a variety of conditions. The server 70 downloads the biometric information to the biometric information presentation apparatus 20. The user of the biometric information presentation apparatus 20 can feel physically the statuses of a variety of persons.

For example, the user can feel the heart beat, respiration, brain wave, blood pressure of a soccer player in a soccer game, running rhythm and heart beat of a sprint runner, or respiration of a swimmer.

The user can also feel interesting biometric information, for example, of a musician playing in a concert, a painter or an artist at work, a performing actor, a politician in a speech, a pilot in flight, a race driver in a race, etc.

The user may recognize a difference between the biometric information of an experienced person and the biometric information of an inexperienced person, performing skydiving, or scuba diving, or participating in a marathon race.

Without particularly identifying a subject, his or her biometric information during sleep or in commute may be known. Such a system may be used not only for mere pleasure but also for particular research or study.

The system where the biometric information detection and transmission apparatus 1 directly transmits the biometric information to the biometric information presentation apparatus 20 conveniently allows the biometric information to be shared among close persons such as a group of friends or a family.

For example, a small child may quickly fall asleep or calm down by allowing him or her to feel the heart beat of his or her mother.

A parent may easily recognize his or her baby's feelings or detect something wrong by feeling the biometric information of the baby.

The present invention is not limited to the above-described embodiments. The biometric information detection and transmission apparatus 1, the server 70, and the biometric information presentation apparatus 20 may be changed or modified.

For example, the system of FIG. 1A may be operated as a pay system. The biometric information presentation apparatus 20 accesses the server 70, and performs a predetermined billing process and a registration process with the server 70 before downloading the biometric information.

The biometric information detection and transmission apparatus 1 may transmit only part of the biometric information permitted and selected by the subject instead of transmitting all the biometric information. When the living body sensor 5 in the biometric information detection and transmission apparatus 1 can detect the heart rate, blood pressure, perspiration and brain wave, the subject may permit only the heart rate information to be transmitted. The upload data to the server 70 thus contains only the heart rate information.

The biometric information detection and transmission apparatus 1 may also be mounted on pets including dogs and cats. The biometric information of the pet is detected and uploaded to the server 70 or directly transmitted to the biometric information presentation apparatus 20. An owner of the pet can thus feel the biometric information of the pet.

It should be understood by those skilled in the art that various modifications, combinations, sub-combinations and alterations may occur depending on design requirements and other factors insofar as they are within the scope of the appended claims or the equivalents thereof.

1. A biometric information sharing system, comprising a biometric information detection and transmission apparatus, and a biometric information presentation apparatus,
the biometric information detection and transmission apparatus comprising:
detection means for detecting biometric information of a subject; and
transmission means for transmitting the biometric information detected by the detection means; and
the biometric information presentation apparatus comprising:
communication means for performing information communications;
actuation means for presenting the biometric information in a predetermined mode; and
control means for causing the communication means to receive the biometric information and controlling the actuation means in response to the biometric information received by the communication means.

2. The biometric information sharing system according to claim 1, further comprising server including storage means storing the biometric information,
wherein the transmission means in the biometric information detection and transmission apparatus uploads the biometric information to the server,
wherein the server stores on the storage means thereof the uploaded biometric information, and
wherein the communication means in the biometric information presentation apparatus receives the biometric information downloaded from the storage means in the server.

3. The biometric information sharing system according to claim 1, wherein the biometric information contains at least one piece of information selected from a group consisting of pulse, heart rate, electrocardiogram, electromyogram, respiration, perspiration, galvanic skin response, blood pressure, blood oxygen saturation, skin surface temperature, electroencephalogram, blood flow change, body temperature, body motion, head motion, center of gravity, rhythm of walking and running, and the state of the eyes of the subject.

4. The biometric information sharing system according to claim 2, wherein the server stores on the storage means thereof the uploaded biometric information with identification information of the subject associated therewith.

5. The biometric information sharing system according to claim 4, wherein the communication means in the biometric information presentation apparatus downloads part of the biometric information selected in accordance with the identification information, the biometric information stored on the storage means in the server.

6. A biometric information presentation apparatus, comprising:
communication means for performing information communications;
actuation means for presenting biometric information in a predetermined mode; and
control means for causing the communication means to receive the biometric information and controlling the actuation means in response to the biometric information received by the communication means.

7. The biometric information presentation apparatus according to claim 6, wherein the control means causes the communication means to download part of the biometric information selected from the biometric information stored on an external server.

8. The biometric information presentation apparatus according to claim 7, wherein the server stores the biometric information with identification information of a subject associated therewith, and
wherein the control means selects part of the biometric information to be received, from the biometric information stored on the server, in accordance with the identification information.

9. The biometric information presentation apparatus according to claim 6, wherein the actuation means comprises a vibrator, and
wherein the control means generates a drive control signal in response to the biometric information received by the communication means and controls the vibrator to vibrate in response to the drive control signal.

10. The biometric information presentation apparatus according to claim 6, wherein the actuation means comprises a shape changer, and
wherein the control means generates a drive control signal in response to the biometric information received by the communication means and controls the shape changer to change a shape thereof in response to the drive control signal.

11. The biometric information presentation apparatus according to claim 6, wherein the actuation means comprises a pressure applier, and
wherein the control means generates a drive control signal in response to the biometric information received by the communication means and controls the pressure applier to apply pressure in response to the drive control signal.

12. The biometric information presentation apparatus according to claim 6, wherein the actuation means comprises a temperature changer, and
wherein the control means generates a drive control signal in response to the biometric information received by the communication means and controls the temperature changer to change a temperature thereof in response to the drive control signal.

13. The biometric information presentation apparatus according to claim 6, wherein the actuation means comprises a moisture changer, and
wherein the control means generates a drive control signal in response to the biometric information received by the communication means and controls the moisture changer to change a moisture state thereof in response to the drive control signal.

14. The biometric information presentation apparatus according to claim 6, wherein the actuation means comprises an image display, and
wherein the control means generates an image control signal in response to the biometric information received by the communication means and controls the image display to display an image in response to the image signal.

15. The biometric information presentation apparatus according to claim 6, wherein the actuation means comprises an audio output unit, and
wherein the control means generates an audio signal in response to the biometric information received by the communication means and controls the audio output unit to output an audio in response to the audio signal.

16. The biometric information presentation apparatus according to claim 6, wherein the control means controls the actuator means on a real-time basis based on the biometric information continuously received by the communication means.

17. The biometric information presentation apparatus according to claim 6, further comprising storage means,
wherein the control means causes the storage means to store the biometric information received by the communication means, and controls the actuator means in response to the biometric information read from the storage means.

18. A biometric information presentation method, comprising
receiving biometric information;
generating a drive control signal controlling a presentation operation in a predetermined mode in response to the biometric information; and
executing an operation responsive to the drive control signal.

19. A biometric information sharing system, comprising a biometric information detection and transmission apparatus, and a biometric information presentation apparatus,
the biometric information detection and transmission apparatus comprising:
a detection unit detecting biometric information of a subject; and
a transmission unit transmitting the biometric information detected by the detection unit; and
the biometric information presentation apparatus comprising:
a communication unit performing information communications;
an actuation unit presenting the biometric information in a predetermined mode; and
a control unit causing the communication unit to receive the biometric information and controlling the actuation unit in response to the biometric information received by the communication unit.
